(19) United States
(12) Patent Application Publication
(10) Pub. No.: US 2016/0150331 A1
(43) Pub. Date: May 26, 2016

(54) ADJUSTABLE VENTING FOR HEARING INSTRUMENTS

(71) Applicant: EarLens Corporation, Menlo Park, CA (US)

(72) Inventor: Stuart W. Wenzel, San Carlos, CA (US)

(21) Appl. No.: 14/554,606

(22) Filed: Nov. 26, 2014

(51) Int. Cl. H04R 25/00

(52) U.S. Cl. CPC H04R 25/652; H04R 2460/09

(57) ABSTRACT

An ear tip apparatus for use with a hearing device is provided and comprises a malleable structure. The malleable structure is sized and configured for placement in an ear canal of a user. The malleable structure is deformable to allow an adjustable venting of the ear canal, thereby minimizing the occlusion effect. Methodology for adjusting a degree of venting of the ear canal is also provided, including the automatic adjustments. Adjusting the degree of venting may be done in response to one or more of detected feedback or an environmental cue.

### BACKGROUND

The present disclosure relates generally to hearing systems, devices, and methods. Although specific reference is made to hearing aid systems, embodiments of the present disclosure can be used in many applications in which a diagnostic, treatment, or other device is placed in the ear.

Hearing is an important sense for people and allows them to listen to and understand others. Natural hearing can include spatial cues that allow a user to hear a speaker, even when background noise is present.

Hearing devices can be used with communication systems to help the hearing impaired. Hearing impaired subjects need hearing aids to verbally communicate with those around them. In-canal hearing aids have proven to be successful in the marketplace because of increased comfort and an improved cosmetic appearance. Many in-canal hearing aids, however, have issues with occlusion. Occlusion is an unnatural, tunnel-like hearing effect which can be caused by hearing aids which at least partially occlude the ear canal. In at least some instances, occlusion can be noticed by the user when he or she speaks and the occlusion results in an unnatural sound during speech. To reduce occlusion, many in-canal hearing aids have vents, channels, or other openings. These vents or channels allow air and sound to pass through the hearing aid, specifically between the lateral and medial parts of the ear canal adjacent the hearing aid placed in the ear canal.

In some cases, occlusion vents in current in-canal hearing aids are less than ideal. For example, many in-canal hearing devices have occlusion vents with fixed sizes, limiting the effectiveness of the occlusion vents. Generally, a user selects, with the help of an audiologist or doctor, the best sounding hearing aid from a choice of multiple hearing aids. The user then selects a set of vented or non-vented ear tips to provide the best sound at the point of sale. However, in daily life, the acoustic environment will change, and the sound provided by the chosen ear tips may not be best for every situation. Historically, when the acoustic environment changes, the user has only been able to adjust the loudness or volume of the hearing instrument or change the vented tips. Changing the volume can be done quickly without removing the hearing instrument. In contrast, changing the vents is cumbersome, requires removing the hearing instrument, and is best done with the help of a professional fitter, which make the adjustment process even less convenient. Moreover, merely replacing the ear tips in use will not compensate for changes to hearing that can occur in a dynamic environment.

The hearing systems, devices, and methods described herein will address at least some of the above concerns.

### SUMMARY

Generally, a variety of devices and methods for reducing occlusion for an in-canal hearing device are provided in the present disclosure. In various embodiments, in situ adjustable venting via manual or automatic, for example, electronic means, will provide another powerful way to improve sound quality in real time.

According to some embodiments, the devices will generally comprise a gel (or a gel-filled bladder) or other malleable element or structure which is shaped to define one or more channels for ear canal venting when placed in the ear canal. The gel or other malleable element may be deformed to vary the size of the channel(s) and thereby the degree of venting provided. The degree of venting may be adjusted in response to a variety of cues such as for feedback or for the ambient acoustic environment. Also, the gel or other malleable element or structure may be soft and conformable such that placement in the sensitive, bony portion of the ear canal minimally irritates the tissue therein.

According to one aspect disclosed herein, an ear tip apparatus may comprise a malleable structure. The malleable structure may be sized and configured for placement in an ear canal of a user. For instance, the malleable structure may have a cross-section shaped to define at least one channel between an inner wall of the ear canal and an outer surface of the malleable structure for venting of the ear canal. The malleable structure may be deformable to adjust the cross-section thereof so as to vary a size of the at least one channel to adjust a degree of venting provided by the at least one channel.

In various embodiments, the ear tip apparatus may further comprise an actuator coupled to the malleable structure and operable to cause the malleable structure to deform. The actuator may comprise a slider configured for translation and/or rotation relative to the malleable structure. For example, the slider may comprise one or more threads to facilitate rotation relative to the malleable structure. Translating and/or rotating the slider toward the malleable structure may deform the malleable structure to increase the size of the at least one channel to reduce the degree of venting provided by the at least one channel. The actuator may further comprise an elongate element coupled to the malleable structure and the slider. The malleable structure may be disposed over the elongate element and the slider may be translatable over the elongate element. The elongate element may comprise one or more of a shaft, wire, or a post.

In various embodiments, the actuator may be configured to vary the degree of venting provided by the at least one channel in response to one or more of detected feedback or an environmental cue. The actuator may comprise one or more of a circuitry, a processor, or a mechanical element adapted to be responsive to one or more of the detected feedback or the environmental cue. The detected feedback or the environmental cue may be indicated from a sensor in communication with the actuator. The sensor may comprise one or more of a microphone, an accelerometer, a vibration sensor, an internal sensor of the ear tip apparatus, or a sensor of a control device external of the ear tip apparatus (e.g., a BTE unit). The communication may be at least partially electronic and/or wireless. The actuator may be configured to vary the degree of venting provided by the at least one channel in response to one or more of a volume or a sound directionality of an ambient environment. The actuator may be configured to increase the degree of venting in a loud ambient environment, thereby allowing the user to hear more unprocessed sound, or to decrease the degree of venting in a loud ambient environment, thereby allowing the user to hear more processed sound.

In various embodiments, the malleable structure may be deformable between a low cross-sectional area configuration and a high cross-sectional area configuration. The channel(s) may provide more venting when the malleable structure is in the low cross-sectional area configuration than when in the high cross-sectional area configuration. The malleable structure may be biased to assume the low cross-sectional area configuration. The malleable structure may have one or more of a Y-shaped, X-shaped, or cross-shaped cross-section.

In various embodiments, the malleable structure may comprise a gel. The malleable structure may comprise in certain embodiments a fluid-filled bladder. The fluid-filled bladder may comprise a bladder wall and a bladder fluid, and the bladder wall may comprise one or more of a stiff plastic or an elastomeric material. The stiff plastic or elastomeric material may comprise one or more of silicone, parylene, nylon, a PEBA material, Pebax, or polyurethane. The bladder fluid may comprise one or more of a gas, a liquid, or a gel. The bladder fluid may comprise air or nitrogen. The gel may comprise one or more of a silicone gel, a viscous hydrophilic fluid, a viscous hydrophobic material, a thixotropic material, a viscoelastic material, a dilatant material, a rheopectic material, Nusil MED-6670, Nusil MED-6346, Nusil MED-6345, a polyurethane gel, a polyvinylpyrrolidone gel, a polyethylene glycol gel, glycerol, thickened glycerol, petroleum jelly, mineral oil, lanolin, silicone oil, or grease.

Typically, the ear tip apparatus is inserted into the ear canal as a stand-alone unit contacting the inner wall of the ear canal. In various embodiments, however, the ear tip apparatus may be provided as a component of a greater hearing device. This hearing device may comprise a body configured for placement within an ear canal of a user. The body may define an inner channel, and the ear tip apparatus may be placed within the inner channel of the body. The channel(s) may be defined between an inner wall of the body and an outer surface of the malleable structure of the ear tip.

According to another aspect disclosed herein, a method for reducing occlusion in a hearing device placed in an ear canal of a user may comprise a step of deforming a malleable structure placed in the ear canal. Such deformation may vary a size of at least one channel to adjust a degree of venting provided by the at least one channel. The malleable structure may be sized and configured for placement in the ear canal and may have a cross-section shaped to define the at least one channel between the inner wall of the ear canal and an outer surface of the malleable structure. The malleable structure may comprise a gel.

In various embodiments, the malleable structure is deformed by translating or rotating a slider relative to the malleable element. The slider may be translated or rotated over an element, wherein one or more of the slider or the malleable structure is disposed over the element. Translating and/or rotating the slider relative to the malleable structure may transition the malleable structure from a low cross-sectional area configuration to a high cross-sectional area configuration and/or move the slider toward the malleable structure.

In various embodiments, the method may further comprise a step of adjusting the degree of venting in response to one or more of detected feedback or an environmental cue. The detected feedback or the environmental cue may be indicated from a sensor. The sensor may comprise one or more of a microphone, an accelerometer, a vibration sensor, an internal sensor of the hearing device, or a sensor of a control device external of the hearing aid. The degree of venting may be increased in a loud ambient environment, thereby allowing the user to hear more unprocessed sound; or, the degree of venting may be decreased in a loud ambient environment, thereby allowing the user to hear more processed sound.

According to one aspect disclosed herein, a hearing device may comprise a body and first and second baffles. The body may be configured for placement within an ear canal of a user. The first and second baffles may each be coupled to the body and may each have at least one opening for venting of the ear canal. One or more of the first or second baffles may be rotatable relative to one another to vary the alignment of their openings with one another to adjust a degree of venting through the body of the hearing device. Each baffle may have a plurality of openings.

In various embodiments, the first and second baffles are rotatable to fully align the opening(s) of the first baffle and the opening(s) of the second baffle with one another to allow full venting through the aligned openings. The first and second baffles may be rotatable to misalign the opening(s) of the first baffle with the opening(s) of the second baffle such that no venting or a partial/reduced venting is allowed through the openings and baffles.

In various embodiments, the hearing device further comprises an actuator configured to vary the alignment of the opening(s) of the first baffle and the opening(s) of the second baffle with one another. The actuator may be configured to vary the alignment of the opening(s) of the first baffle and the opening(s) of the second baffle with one another in response to detected feedback or an environmental cue. The detected feedback or the environmental cue may be indicated from a sensor in communication with the actuator. The sensor may comprise one or more of a microphone, an accelerometer, a vibration sensor, an internal sensor of the hearing device, or a sensor of a control device external of the hearing device (e.g., a BTE unit). The actuator may be in electronic communication with the sensor. The actuator may be configured to vary the alignment of the opening(s) of the first baffle and the opening(s) of the second baffle with one another in response to one or more of a volume or a sound directionality of an ambient environment. The actuator may be configured to more closely align the opening(s) of the first baffle and the opening(s) of the second baffle with one another in a loud ambient environment, thereby allowing the user to hear more unprocessed sound; or the actuator may be configured to less closely align the opening(s) of the first baffle and the opening(s) of the second baffle with one another in a loud ambient environment, thereby allowing the user to hear more processed sound.

According to another aspect disclosed herein, an ear tip apparatus (e.g., hybrid ear tip) comprising a hard core and a gel portion is provided. The hard core may be configured for placement in an ear canal and may have a lateral portion and a medial portion. The gel portion is disposed over at least the medial portion of the hard core and configured to deform and conform to the ear canal.

In various embodiments, the medial portion is configured to conform to a cartilaginous portion of the ear canal.

In various embodiments, an exposed outer surface of the hard core is configured to end at a location of the ear tip apparatus configured to be placed at the isthmus of the ear canal when the ear tip apparatus is inserted in the ear canal.

In various embodiments, an outer surface of the gel portion may be configured or shaped to define one or more channels for venting of the ear canal.

In various embodiments, the ear tip apparatus further comprises one or more transducers for transmitting sound to the user. The one or more transducers may be housed within the hard core.

In various embodiments, the gel portion comprises one or more of a silicone gel, a viscous hydrophilic fluid, a viscous hydrophobic material, a thixotropic material, a viscoelastic material, a dilatant material, a rheopectic material, Nusil MED-6670, Nusil MED-6346, Nusil MED-6345, a polyurethane gel, a polyvinylpyrrolidone gel, a polyethylene glycol gel, glycerol, thickened glycerol, petroleum jelly, mineral oil, lanolin, silicone oil, or grease.

Other features and advantages of the devices and methodology of the present disclosure will become apparent from the following detailed description of one or more implementations when read in view of the accompanying figures. Neither this summary nor the following detailed description purports to define the invention. The invention is defined by the claims.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

It should be noted that the drawings are not to scale and are intended only as an aid in conjunction with the explanations in the following detailed description. In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings. A better understanding of the features and advantages of the present disclosure will be obtained by reference to the following detailed description that sets forth illustrative embodiments, in which the principles of the disclosure are utilized, and the accompanying drawings of which:

FIG. 1 is a section view of a hearing instrument or ear tip placed within the ear canal of a human ear, according to some embodiments;

FIGS. 2A and 2B are examples of perspective views of an ear tip in a high venting configuration (FIG. 2A) and a low venting configuration (FIG. 2B) placed within the ear canal, according to some embodiments;

FIGS. 3A and 3B are side views of the ear tip of FIG. 2A in the high venting configuration (FIG. 3A) and the low venting configuration (FIG. 3B), according to some embodiments;

FIGS. 4A and 4B are perspective views of the ear tip of FIG. 2A in the high venting configuration (FIG. 4A) and the low venting configuration (FIG. 4B), according to some embodiments;

FIG. 5A is a perspective view of an example of the ear tip in the high venting configuration, according to some embodiments;

FIG. 5B is a front view of the ear tip adjusted to the high venting configuration, according to some embodiments;

FIG. 6 shows a section view of another example of the ear tip in the high venting configuration, according to some embodiments;

FIG. 7A shows a perspective front view of yet another example of a double-baffled ear tip in a high venting configuration, according to some embodiments;

FIG. 7B shows a perspective view of the back of the ear tip of FIG. 7A, according to some embodiments;

FIGS. 8A, 8B, and 8C show perspective views of the back of the ear tip of FIG. 7A as the ear tip is transitioned from the high venting configuration (FIG. 8A) to a low venting configuration (FIG. 8B) to a no venting configuration (FIG. 8C), according to some embodiments;

FIGS. 9A and 9B show section views of a double-baffled ear tip with baffle(s) translated to adjust venting from a minimal venting configuration (FIG. 9A) to a high venting configuration (FIG. 9B), according to some embodiments;

FIGS. 10A and 10B show side views of known rigid ear tips placed in the ear canal;

FIGS. 11A, 11B, and 11C show side views of examples of hybrid ear tips having a gel portion surrounding a hard core or shell and being placed in the ear canal, according to some embodiments;

FIG. 12A shows a perspective view of a hybrid ear tip placed in the ear canal, according to some embodiments;

FIG. 12B shows a perspective view of the hybrid ear tip of FIG. 12A, according to some embodiments;

FIG. 12C shows a front view of the hybrid ear tip of FIG. 12A, according to some embodiments;

FIGS. 13A and 13B show perspective views of yet another example of an ear tip having a handle portion, according to some embodiments;

FIGS. 14A and 14B show perspective view of a wax ear tip mold, according to some embodiments;

FIGS. 15A, 15B, and 15C show perspective views of an example of a complete ear tip assembly, according to some embodiments;

FIG. 16A shows a perspective view of a thin shell ear tip, according to some embodiments; and

FIG. 16B shows a front view of the thin shell ear tip of FIG. 16A.

### DETAILED DESCRIPTION

In the following detailed description, reference is made to the accompanying drawings that show, by way of illustration, some examples of embodiments in which the disclosure may be practiced. In this regard, directional terminology, such as “right”, “left”, “upwards”, “downwards”, “vertical”, “horizontal” etc., are used with reference to the orientation of the figure(s) being described. Because components or embodiments of the present disclosure can be positioned or operated in a number of different orientations, the directional terminology is used for purposes of illustration and is in no way limiting. It is to be understood that other embodiments may be utilized and structural or logical changes may be made without departing from the scope of the present disclosure.

The term “gel” as used herein refers to any number of materials that are soft and viscoelastic. The mechanical properties of a “gel” as used herein may range from a viscous liquid such as honey or mineral oil to a soft elastic solid, such as gelatin. For example, a “gel” may comprise a soft, weakly cross-linked solid that can deform and flow under applied force and may spring back slowly upon removal of the applied force. One example is Nusil MED-6346 silicone gel. The “gels” of the present disclosure may be homogenous or heterogeneous (as in slurries, colloids, and emulsions). The “gels” of the present disclosure may be hydrophobic or hydrophilic. Heterogeneous gels may include different phases that have different solubility and transport properties; for example, a hydrophobic, contiguous, soft polymer filled partially with particles of hydrophilic polymers. Such a composite material may accrue performance advantages from each material, such as elasticity, chemical resistance, and moisture transport. The “gels” of the present disclosure may include any low-shear modulus material based on chemistries such as silicone, polyurethane, polyvinylpyrrolidone, and polyethylene glycol. The “gels” of the present disclosure may also include foam materials such as those made of silicone, polyurethane, or the like and/or foam materials impregnated with liquids or gels. Additional examples of “gels” are further described below in reference to various embodiments.

The terms “operatively connected,” “coupled,” or “mounted,” or “attached” as used herein, means directly or indirectly coupled, attached, or mounted through one or more intervening components.

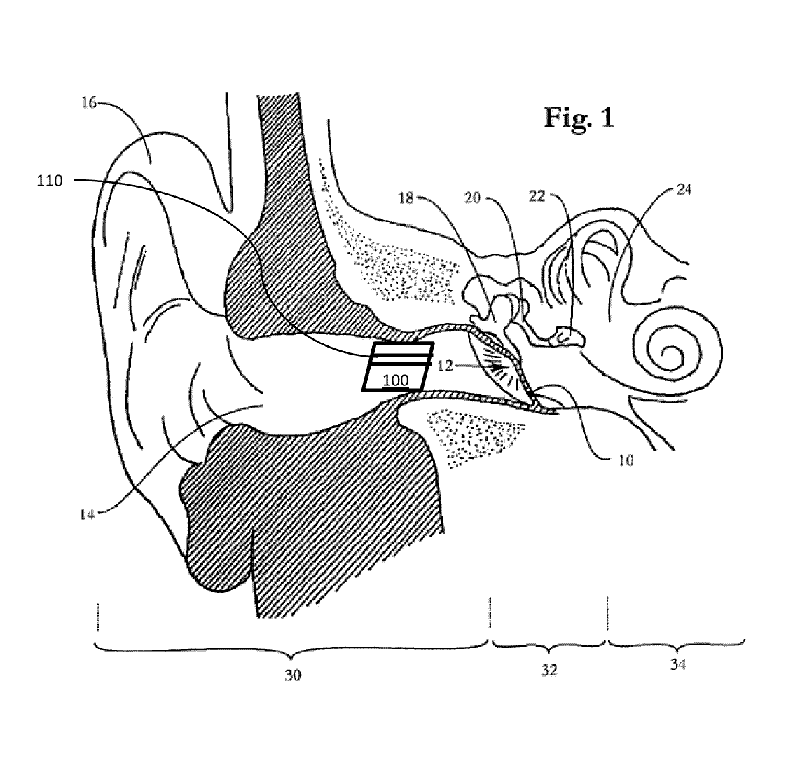

FIG. 1 shows a cross sectional view of outer ear 30, middle ear 32 and inner ear 34 (part). The outer ear comprises primarily of the pinna 16 and the ear canal 14. The middle ear is bounded by the tympanic membrane (ear drum) 10 on one side, and contains a series of three tiny interconnected bones: the malleus (hammer) 18; the incus (anvil) 20; and the stapes (stirrup) 22. Collectively, these three bones are known as the ossicles or the ossicular chain. The malleus is attached to the tympanic membrane 10 while the stapes, the last bone in the ossicular chain, is coupled to the cochlea 24 of the inner ear.

Many hearing instruments or hearing aids include “ear tips” that fit inside the external auditory canal or ear canal 14 to deliver sound to the eardrum or tympanic membrane 10. Ear tips are support structures that suspend and retain a sound tube or receiver inside the ear canal. A sound tube, for example, may be a hollow plastic tube that guides sound generated in an external hearing instrument, while a receiver is a miniature speaker that is connected to an external hearing instrument via wires. To minimize occlusion, such ear tips generally provide venting through the ear canal through an opening, channel, or vent along its length. As discussed above, many current ear tips have fixed vent sizes that may limit their effectiveness. Another types of hearing instruments, for example, completely-in-canal (CIC) hearing instruments could also benefit from adjustable venting.

As shown in FIG. 1, a hearing device or ear tip 100 may be placed within the ear canal 14, for example, between the lateral cartilaginous part and the medial body part. The hearing device 100 may include one or more openings, channels, or vents 110 to allow the ear canal 14 to vent.

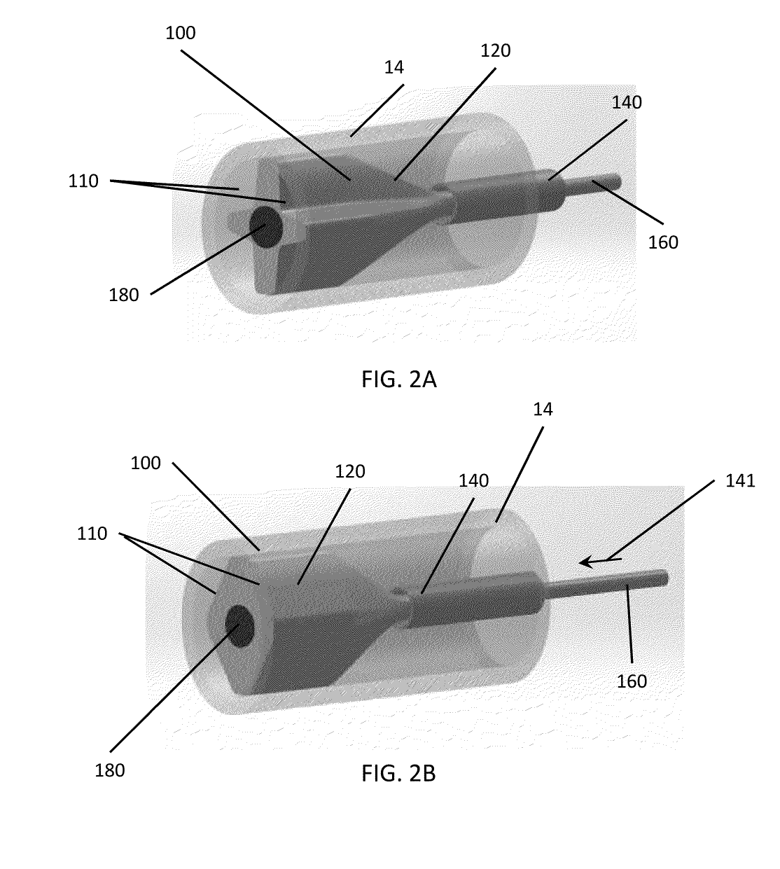

FIGS. 2A and 2B show the hearing device 100 in place in the ear canal 14. FIG. 2A shows the hearing device 100 in a low cross-sectional area, high venting configuration. FIG. 2B shows the hearing device 100 in a high cross-sectional area, low venting configuration. The hearing device or ear tip 100 may comprise a malleable element or structure 120, a slider 140, and an element 160. The hearing device 100 may also comprise an output transducer 180. For example, the output transducer 180 may comprise a laser photodiode or other emitter for emitting an optical signal to be received by a device placed on the tympanic membrane 10 such as the Contact Hearing Device available from EarLens Corporation of Menlo Park, Calif. Systems and methods for photo-mechanical hearing transduction are also described in co-assigned U.S. Pat. Nos. 7,668,325, 7,867,160, 8,396,239, 8,696,541, 8,715,152, 8,824,715, and 8,858,419, the full contents of which are incorporated herein by reference. In further examples and embodiments, the output transducer may comprise a miniature speaker or receiver.

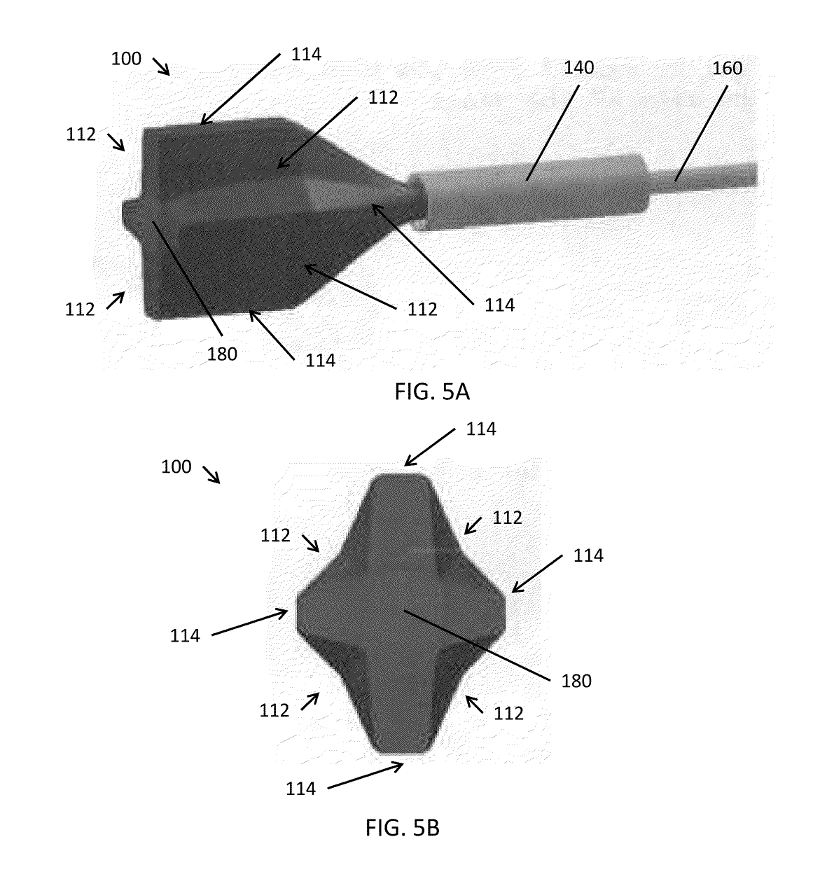

The malleable element 120 may be conically shaped. The malleable element 120 may have a distal or medial portion adapted or configured to be in contact with and be flush with the inner wall of the ear canal 14 and a tapered proximal or lateral portion. The malleable element 120 in the low cross-sectional area, high venting configuration may be shaped to define one or more channels 110. In one example shown in FIG. 2A, the malleable element 120 has a cross-shaped cross-section to define four channels 110 between the outer surface of the malleable element and the inner wall of the ear canal 14. The cross-shaped cross-section further defines four ear canal wall contacting extensions 114 as shown in FIGS. 5A, 5B. The malleable element 120 may also have other cross-sectional shapes, such be I-shaped, Y-shaped, or X-shaped, or have a plurality of channels 110, to name a few. While the malleable element 120 is shown and described as being configured to be in contact with the inner wall of the ear canal 14, in some embodiments, the malleable element 120 may be housed, for example, in a shell, housing or other device body that may be molded to fit within the ear canal.

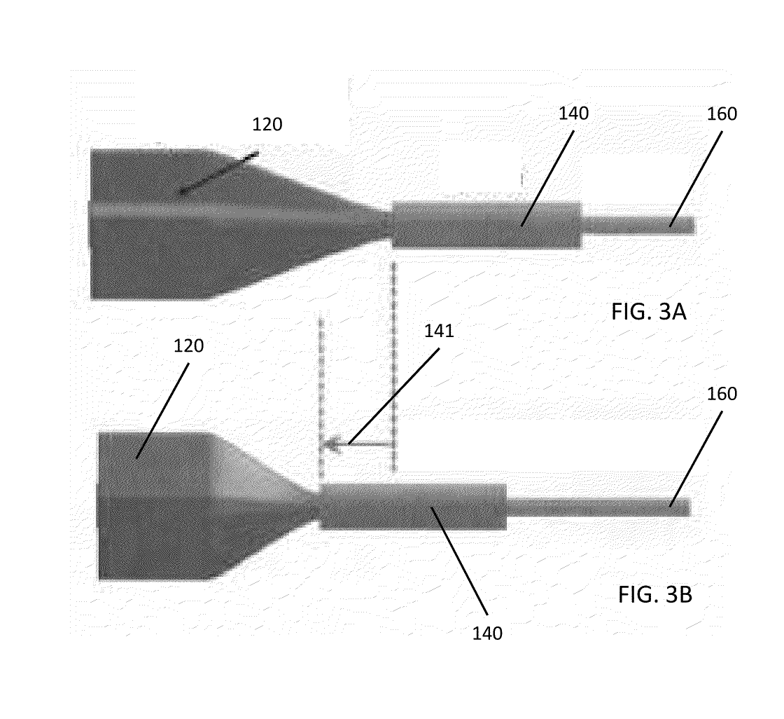

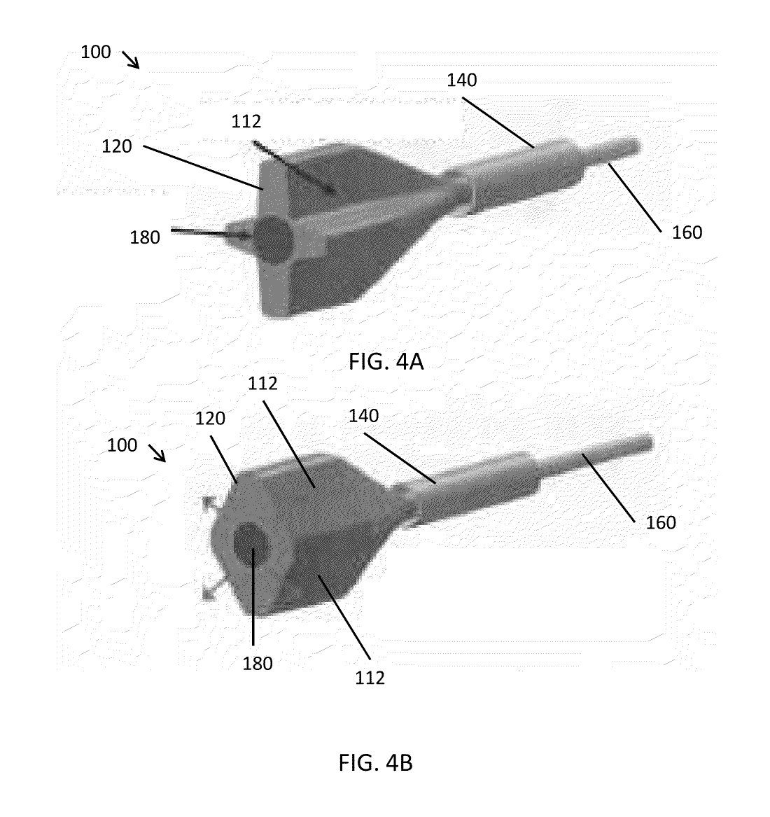

FIGS. 3A and 3B show side views of an example of the transition of the ear tip 100 from the low cross-sectional area, high venting configuration, shown by FIG. 3A, to the high cross-sectional area, low venting configuration, shown by FIG. 3B. In this example the slider 140 may be advanced toward the malleable element 120 (or toward the tympanic membrane 10) over the element 160 (for example, a wire or a shaft) as shown by arrow 141 in FIGS. 2B and 3B. As a result, the material of the malleable element 120, for example gel, is then urged radially outward to decrease the cross-sectional area of the channels 110. In particular, relief or “cut-away” areas 112 (shown, for example, in FIGS. 4A and 4B) which in part define the channels 110 may bulge outwardly. FIGS. 5A and 5B show a perspective view and a front view of the ear tip 100 and the relief or “cut away” areas 112.

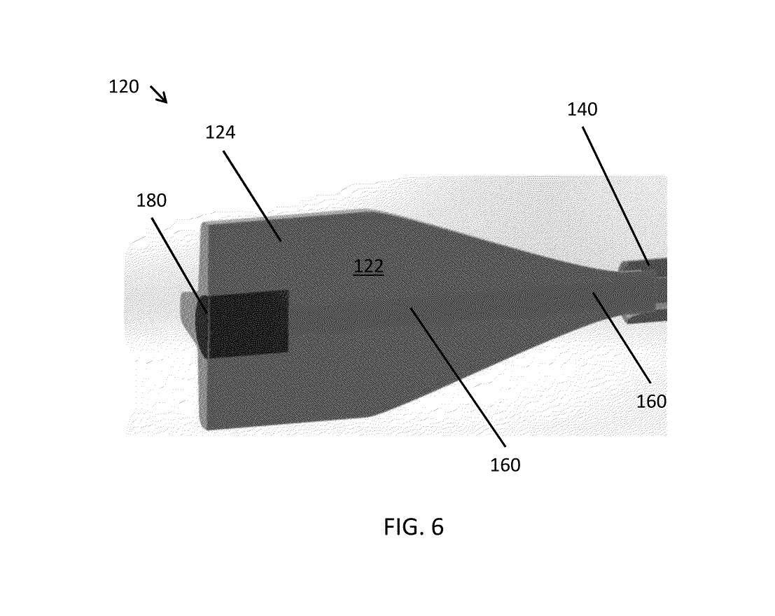

FIG. 6 shows an alternative embodiment of the malleable element 120. In this embodiment, the malleable element 120 comprises a gel or fluid 122 surrounded by a thin bladder 124. In various embodiments, the malleable element 120 may be biased to assume the low cross-sectional area, high venting configuration. The malleable element 120 may be disposed radially over the element 160. Advancing the slider 140 in the distal or medial direction may squeeze the bladder 124 to force the gel 122 radially outward. The slider 140 may be movable continuously toward or away from the malleable element 120. Alternatively or in combination, the slider 140 may be movable between a plurality of discrete locations toward or away from the malleable element 120 to achieve specific size and/or configuration of the channels 110. The output transducer 180 may be coupled, for example, to distal ends of the element 160 and the malleable element 120. The element 160 may comprise a shaft, a post, or a wire, to name a few exemplary structures. In some embodiments, the element 160 may be elongated and may comprise a shaft and/or one or more wires to provide power and/or signals to the output transducer 180.

The gel 122 may be comprised of one or more of a silicone gel, a viscous hydrophilic fluid, a viscous hydrophobic material, or a gas, to name a few. Examples of silicone gels that may be used as the gel or fluid 122 include NuSil MED-6670, NuSil MED-6346, and NuSil MED-6345, available from NuSil Technology LLC of Carpintera, Calif., and polyurethanes, to name a few. Examples of viscous hydrophilic fluids that may be used as the gel 122 include glycerol and glycerol thickened with thickening agents such as carbopol, polyvinylprolidone, poly (ethylene glycol), etc., to name a few. Examples of viscous hydrophobic materials that may be used as the gel or fluid 122 include petroleum jelly, mineral oil, lanolin, silicone oils, and grease, to name a few. Examples of gases which may be used as the gel or fluid 122 include air or nitrogen. Examples of other filler materials that may be used as the gel or fluid 122 include viscous fluids and viscoelastic materials (including thixotropic and dilitant), to name a few.

In some embodiments, the malleable element 120 comprises the gel 122 without the thin bladder 124. In such embodiments, the gel or 122 may comprise a soft elastic or viscoelastic (including solid) material.

The thin bladder 124 may have different thickness and/or stiffness in some areas versus others. For example, the relief or “cut away” areas 112, as shown by FIGS. 5A and 5B, may be more elastic than the contact areas 114 which are configured to contact the inner wall of the ear canal 14. The thin bladder 124 may be comprised of a stiff plastic or an elastomeric material. Examples of stiff plastics include parylene, nylon, PEBA materials (such as Pebax), and polyurethane, to name a few. Examples of elastomeric materials include silicone, polyurethane, PEBA, and nylon, to name a few.

The outer surface of the malleable element 120, including the outer surface of the thin bladder 124, may be amenable to sliding, for example, by the exemplary slider 140. To be amenable to sliding, the outer surface of the malleable element 120 may have medium to low friction and little or no track.

In some embodiments, the element 160 may extend laterally or proximally to connect to an external support unit. The external support unit may be a device or an apparatus placed in the ear canal, within the pinna, or behind-the-ear (BTE). The external support unit may comprise components such as a microphone to capture sound, a signal processor to process the captured sound, a power source such as a battery, a sensor, a receiver and/or transmitter to receive/transmit signals or instructions from another internal device, and/or an actuator to operate the slider 140. The sensor may comprise an accelerometer to capture movement and directionality, a thermometer to measure temperature, or a humidity sensor, to name a few. Such sensors may be in communication with the actuator, such as through a wired or a wireless connection. The actuator may comprise a mechanical and/or electrical actuator to operate the slider 140 and vary the venting provided by the malleable element 120. The actuator may be a component of the ear tip 100 in at least some embodiments and applications.

The slider 140 that is used to deform the malleable element 120 of the ear tip 110 is shown just as an example only, and many other appropriate means and mechanisms for actuating, deforming or changing the shape and configuration of the malleable element to adjust the venting is within the scope of the present disclosure. For example, in some embodiments, an electromechanical actuator may be configured to draw low amounts of power and/or consume low or no power to hold a given position or degree of venting. In some embodiments, the actuator may comprise a ratcheting mechanism with a plunger motion such as a solenoid. The ratcheting mechanism may be linear and/or rotational with a screw drive. In some embodiments, the actuator may comprise a pump to pressurize the fluid or gel 122 (for example, within the bladder 124 for those embodiments that comprise such bladder) to change the shape of the malleable element 120. In some embodiments, an electric field may be used to change the size or shape of the gel 122, and therefore, the malleable element.

The actuator may be manually operated (such as by the user, the wearer, and/or a medical professional) or may operate automatically in response to programming, for example, to vary the venting provided based on sensor input. For example, the actuator may be placed in communication with an application loaded on a user-operated mobile computing device such as a smartphone, tablet computer, laptop computer, or the like to operate the slider 140 or any other alternative mechanism. Alternatively or in combination, the user may operate the slider 140 or other appropriate mechanism by hand or with a handheld tool.

The actuator may be responsive to a variety of cues to vary the venting provided by the malleable element 120. Generally, these cues may be environmental or indicative of feedback which may occur when an excess of ear canal venting is provided. The cue may be provided, for example, from a sensor of the hearing aid or ear tip 100 and/or from a sensor of the external support unit such as a BTE unit. For example, the degree of venting provided may be varied in response to the volume of the ambient environment or direction of origin of certain sounds. The degree of venting in a loud ambient environment, for instance, may cause venting to increase to allow the user to hear more unprocessed sound or to decrease to allow the user to hear more processed sound. Further non-limiting examples are as follows.

Feedback may be sensed and the degree of venting provided may be varied to suppress feedback. For example, the ear tip 100 may be in communication with a BTE unit. The microphone of the BTE unit may be used to detect feedback. Feedback may be detected in many ways. Feedback may be detected by detecting a sound signature such as a narrow-band, high frequency sound (e.g., “whistling”) or a loudness greater than the ambient sound level, for example. Feedback may be detected based on sound directionality, such as sound detected as emanating from the ear canal. This directionality may be detected based on the phase difference between microphones (e.g., between a first microphone placed in the ear canal and a second microphone of the BTE unit) and/or the amplitude or loudness of the sound (e.g., absolute amplitude and/or the difference in amplitude detected between different microphones). Feedback may be detected, for example, with a sensor on the ear tip 100. Such sensors may comprise a microphone, an accelerometer to detect vibration associated with high-intensity sound, or a vibrational spectrometer (e.g., MEMS-based), to name a few. Feedback may be detected based on the drive state of internal electronics or circuitry of the ear tip 100. For example, the internal electronics or circuitry may detect when amplifier output is saturating in a given frequency band, which may indicate overdrive and a possible feedback state. Alternatively or in combination, the internal electronics or circuitry may detect when harmonic distortion becomes excessive, which may indicate clipping and feedback.

The ambient acoustic environment may be sensed and the degree of venting provided may be varied accordingly. A loud environment may trigger, for example, increased venting so that the wearer can hear more of the unamplified or unprocessed sound directly or decrease venting to attenuate ambient sounds such that the ear tip 100 can deliver “selective” sound the user may prefer. Such “selective” sound may comprise, for example, the streaming of a telephone call or music from an external computing device such as a smart phone, tablet computer, personal computer, music player, media player, or the like. Other examples include sound from a directional microphone or a microphone array which may be beam forming. In some embodiments, the “selective” sound may be selected using an application loaded onto a computing device. The selection may be based on user settings adjustable in real time or based on chosen profiles that are stored and activated automatically or manually. For example, a profile may be chosen to be more appropriate for quiet environments. This quiet environment profile may trigger increased venting so that the user or wearer of the ear tip 100 may hear more clearly in a one-on-one conversation by taking advantage of the natural directional response of the pinna. Sensing of the acoustic environment can be performed in many ways, including without limitation, by local hearing instrument electronics such as of the ear tip 100 or an associated external unit, by a computing device in communication with the former, or by another server device such as a personal computer.

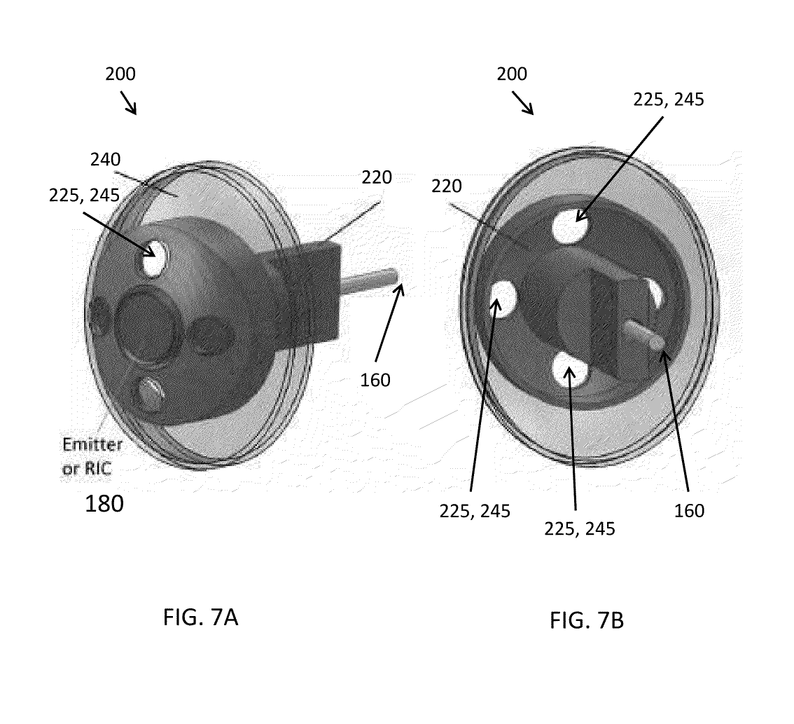

According to another aspect of the present disclosure, FIGS. 7A and 7B show an alternative hearing device or ear tip 200 with adjustable venting. The ear tip 200 may comprise a proximal baffle 220 and a distal baffle or tip 240. The proximal baffle 220 may have one or more openings 225 to provide ear canal venting, and the distal baffle 240 may have one or more openings 245 to provide ear canal venting. The proximal and distal baffles 220, 240 may be coaxial and, either one or both, may be rotatable relative to one another to vary the alignment of the openings 225, 245. As shown in FIGS. 7A and 7B, the openings 225, 245 are fully aligned to provide the maximum degree of venting. The distal baffle 240 may be elastomeric and flexible to be seated within the ear canal 14. The proximal and distal baffles 220, 240 may be disposed over an element 160. The ear tip 200 may further comprise the output transducer 180 disposed on a distal tip of the distal baffle 240.

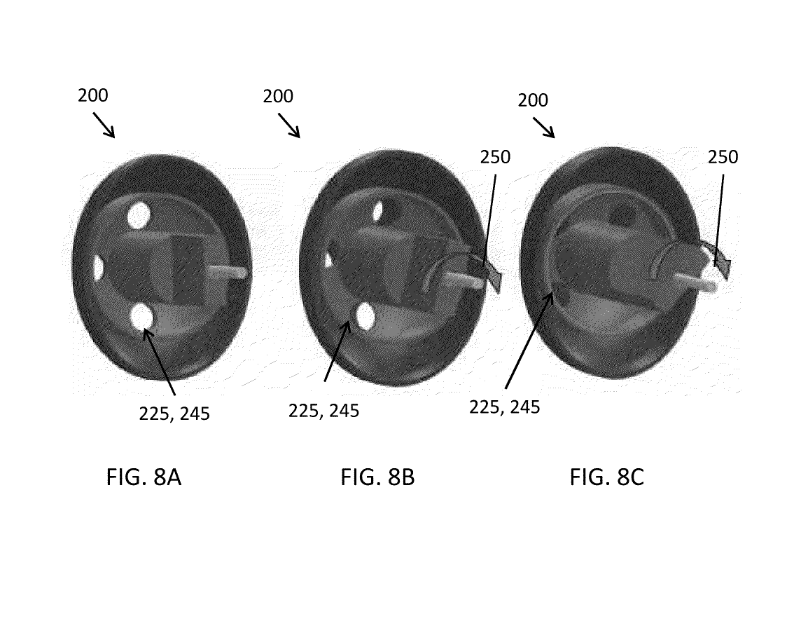

FIGS. 8A to 8C show the operation of the ear tip 200. FIG. 8A shows the ear tip 200 in a configuration to provide maximum venting by fully aligning the openings 225, 245 with one another. As shown in FIGS. 8B and 8C, the proximal baffle 220 may be rotated, for example, in a direction indicated by the arrow 250 to misalign the openings 225, 245 to reduce the degree of venting provided. FIG. 8B shows the ear tip 200 having the proximal baffle 220 rotated to be in an intermediate configuration with less venting. Here, the surfaces of the baffles 220, 240 partially cover the openings 225, 245. FIG. 8C shows the ear tip 200 having the proximal baffle 240 rotated to be in the completely closed configuration with no venting. Here, the surfaces of the baffles 220, 240 fully cover the openings 225, 245.

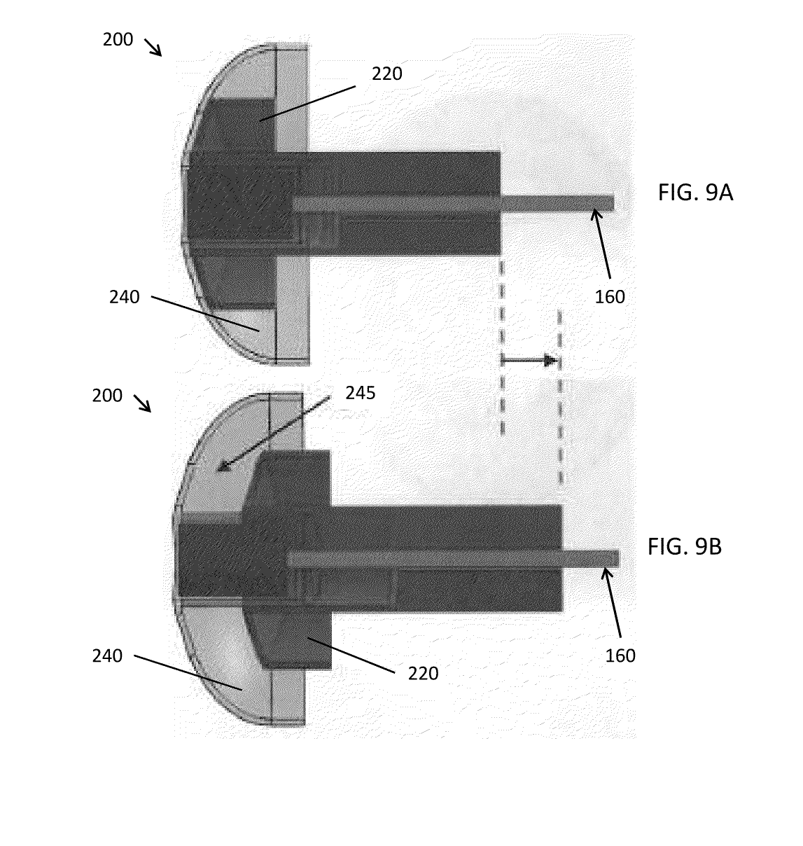

As shown in FIGS. 9A to 9B, the ear tip 200 may alternatively or in combination be configured to vary venting by translation of the baffles 220, 240. For example, the distal baffle 240 may have one or more openings 245 while the proximal baffle 220 may have no openings. The proximal baffle 220 may be advanced to contact the distal baffle 220 to close off venting as shown in FIG. 9A. The proximal baffle 220 may be retracted to allow access to the opening 245 to provide venting as shown in FIG. 9B. In some embodiments, the element 160 may include screw threads so that rotation of the proximal baffle 220 may translate into medial-lateral movement of the proximal baffle 220.

The ear tip 200 may be operated manually or automatically similarly to the ear tip 100 described above. The degree of venting provided by the ear tip 200 may be varied in response to a variety of cues similarly to the ear tip 100 above. For instance, the ear tip 200 may be coupled to an actuator and/or sensor(s), or a processor to vary the degree of venting provided in response to various cues.

According to yet another aspect, the present disclosure further provides for alternative improved ear tips that conform to anatomy, as described below. Such ear tips may be used in various applications and implementations, for example, to suspend or retain output transducers such as a laser photodiode or other emitter for emitting an optical signal to be received by a device placed on the tympanic membrane 10.

Many currently used ear tips are made of a rigid plastic that is generally custom-shaped to the wearer's ear canal. These ear tips typically fit in the cartilaginous portion of the ear canal and are usually oversized such that the soft tissue in this region can stretch and conform to the ear tip to improve retention and sealing. Such soft tissue stretching, however, can cause discomfort in the short term and permanent tissue deformation in the long term.

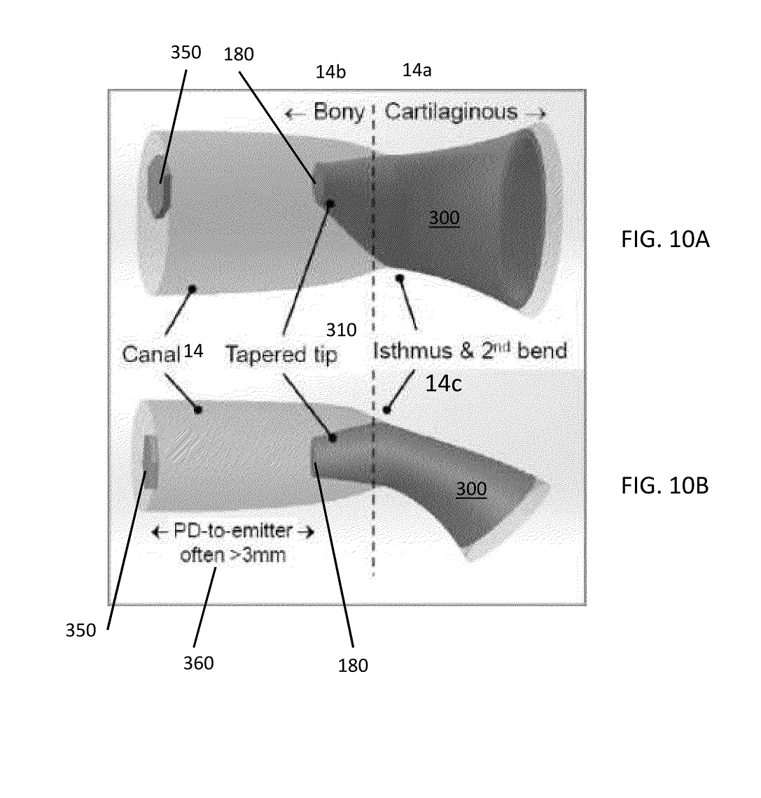

FIGS. 10A and 10B show an example of such known rigid ear tips 300 configured to be placed in the ear canal 14. The ear tip 300 is typically oversized at the cartilaginous portion 14a of the ear canal 14 before transitioning into a tapered tip 310 to be positioned at the bony portion 14b of the ear canal 14. The transition may be at the isthmus or second bend 14c of the ear canal 14. Most ear canals 14 will have a narrowing at the isthmus 14c located just lateral to the beginning of the bony canal 14b. The ear tip 300 may further comprise an output transducer180 located at the distal or medial end of the ear tip 300.

In at least some cases, a tympanic membrane receiver 350 to receive power and/or signal from an optical signal, such as the Contact Hearing Device available from EarLens Corporation of Menlo Park, Calif., may require the photodiode or other output transducer 180 to be close and well-aligned with the receiver 350 to ensure good power transfer and optimal battery life. For example, the output transducer 180 may be positioned at a distance 360, for example, of approximately 3 mm away from the receiver 350 as shown in FIG. 10B. For the photodiode or other output transducer 180 to be positioned at this distance 360, the photodiode or other output transducer 180 will typically be located on the medial end of the ear tip located in the bony portion 14b of the ear canal 14. The tissue in the bony region is very thin (generally 0.1 to 0.2 mm) and sensitive. Pressure applied to the thin tissue should be less than about 20 mmHg to prevent capillary collapse and wound generation. The tissue in the bony region cannot conform to a rigid ear tip since it is surrounded by bone. Indeed, a rigid ear tip should not touch the tissue at all because of the high risk of generating “hot spots,” local regions of high pressure, and wounds, since the soft tissue cannot conform.

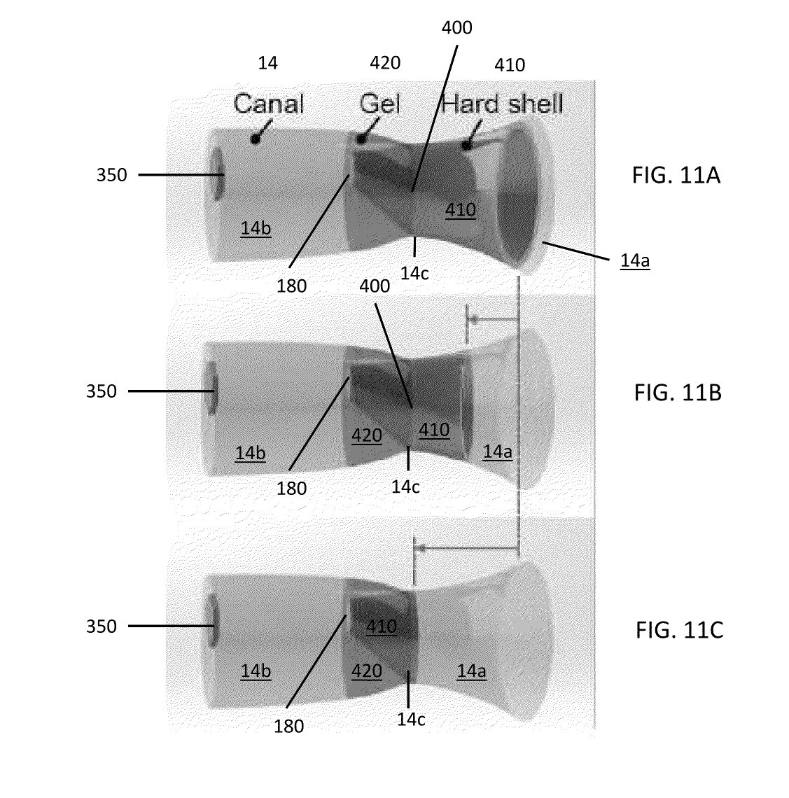

To address at least this concern, ear tips of the present disclosure may be configured to conform to the anatomy with low wall pressure. FIGS. 11A, 11B, and 11C show ear tips 400 according to the present disclosure. The ear tips 400 are shown as placed in the ear canal 14 at one or more of the cartilaginous portion 14a or the bony portion 14b. The ear tips 400 may conform to the deep, bony ear canal 14b to provide alignment with the receiver 350 and retention while maintaining low wall pressure to support ear health and prevent pressure sores.

The ear tips 400 may be referred to as hybrid ear tips as they comprise a hard shell or core 410 and a gel portion 420 disposed over at least the distal or medial tip of the hard shell 410. As shown in FIGS. 11A and 11B, the hard core 410 may conform to the cartilaginous portion 14a of the ear canal 14. The hard shell or core 410 may be substantially rigid and may be longer as in FIG. 11A, or shorter as in FIG. 11B. As shown in FIG. 11C, the hard shell 410 may be entirely housed within the gel portion 420 to be placed within the bony portion 14b of the ear canal 14. In some embodiments, an exposed outer surface of the hard core or shell 410 may have a length such that the hard core does not extend past an isthmus of the ear canal when the ear tip apparatus is inserted in the ear canal, as seen, for example, in FIGS. 11A-C. The gel of the gel portion 420 may comprise any of the gels described herein. The gel of the gel portion 420 may flow and conform to the bony portion 14b of the ear canal. The gel of the gel portion 420 may provide low, uniform hydrostatic pressure to all parts of the canal 14 with little to no “hot spots,” or regions of high pressure. The gel portion 420 may provide gentle wall pressure for comfort (e.g., less than 20 mmHg) and ear health. In some embodiments, a membrane or a bladder can be used to surround and retain the gel as described in reference to the malleable element or malleable structure 120 above, particularly in cases where the gel may not be able to retain its own shape. Providing a surrounding membrane or bladder may also provide lubricity and/or some restoring force to help a soft gel fill and conform. The ear tips 400 may also provide mechanical retention via the isthmus 14c. The gel portion 420 of the ear tips 400 may deform to ease the insertion of the ear tips 400 past the narrowing at the isthmus 14c, and then widen back (e.g., return to its pre-biased or natural wider configuration) to provide gentle retention in the bony portion 14b of the ear canal. As shown in FIGS. 11A and 11B, the hard shell 410 may be oversized so that only its tapered tip can be advanced past the isthmus 14c and that the hard shell 410 is well seated in the cartilaginous portion 14a of the ear canal 14. The ear tips 400 may comprise the output transducer 180 positioned at the distal end of the hard shell 410.

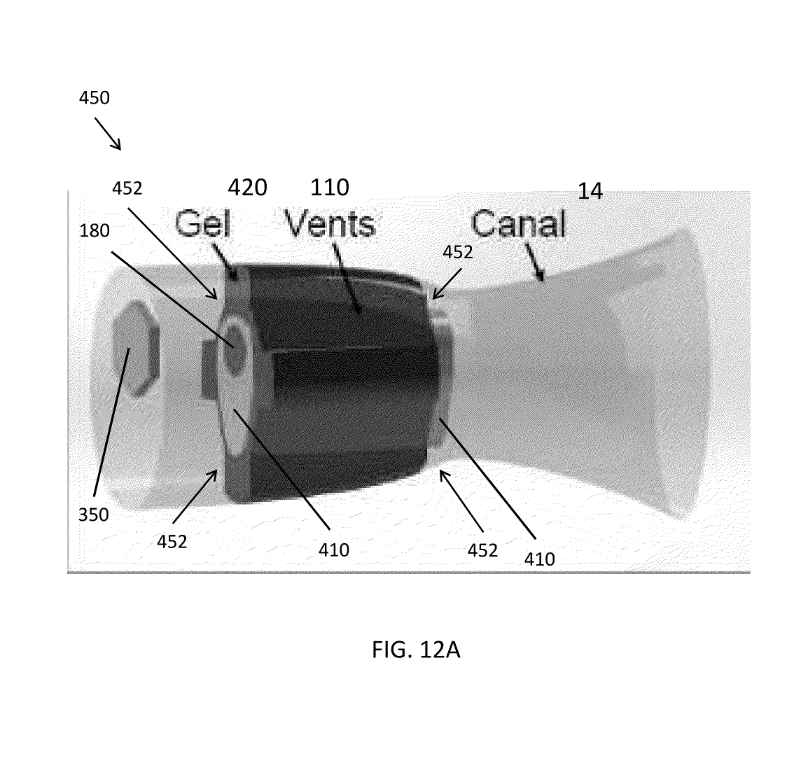

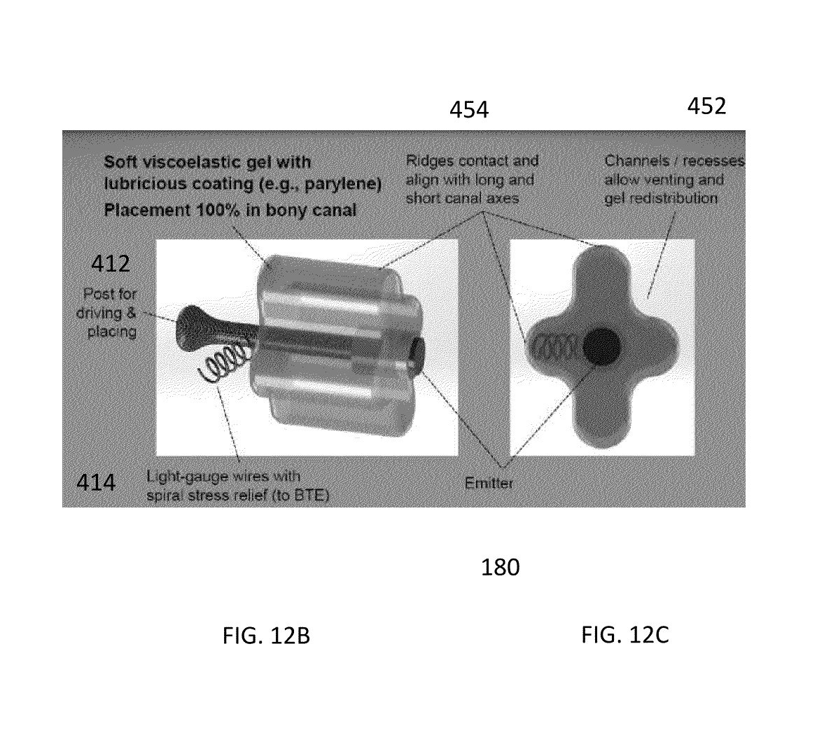

FIGS. 12A, 12B, and 12C show another example of a hybrid ear tip 450, which may be also combined and share features from the embodiments of the ear tips 100 and 300 described above. The ear tip 450 may comprise a hard shell 410 housed within a gel portion 420. The distal end of the hard shell 410 may comprise an output transducer 180 to be aligned with a tympanic membrane receiver 350. For example, in some embodiments the gel portion 420 may comprise a soft viscoelastic gel with a lubricous coating such as parylene. The hybrid ear tip 450 may be configured to be placed entirely within the ear canal 14. The hybrid ear tip 450 may be custom sized and shaped for an individual user. Alternatively, the hybrid ear tip 450 may be provided in a variety of sizes to fit most potential users.

The gel portion 420 may be shaped to define a plurality of channels 110 to provide venting for the ear canal 14. Similarly to the malleable element 120 described above, these channels 110 may be defined between the inner wall of the ear canal 14 and the outer surfaces of the relief or “cut-away” portions 452 of the gel portion 410. The gel portion 420 may be deformed much like the malleable structure or element 120 of the ear tip 100 described above to vary the degree of venting provided by the channels 110. The gel portion 420 may comprise a cross-shape to align with the major and minor axes of the ear canal 14. As shown in FIGS. 12C, the gel portion 420 may comprise ridge portions 454 to contact the ear canal 14 along these axes. The ridge portions 454 may also define the relief or “cut-away” portions 452.

As shown in FIGS. 12B and 12C, the hard shell or core 410 provides convenience for driving/placing the tip within the ear canal and aligning it along the major canal axis. The hard core 410 may also comprise a proximal or lateral post 412 to facilitate the insertion and placement of the ear tip 450. The hard core 410 may further comprise one or more light-gauge wires 414 at the proximal or lateral portion. The wires 414 may have a spiral stress relief and may be configured to be operatively coupled with an external unit such as a BTE unit. The output transducer 180 may receive signals from the external unit through the wires 414, for example.

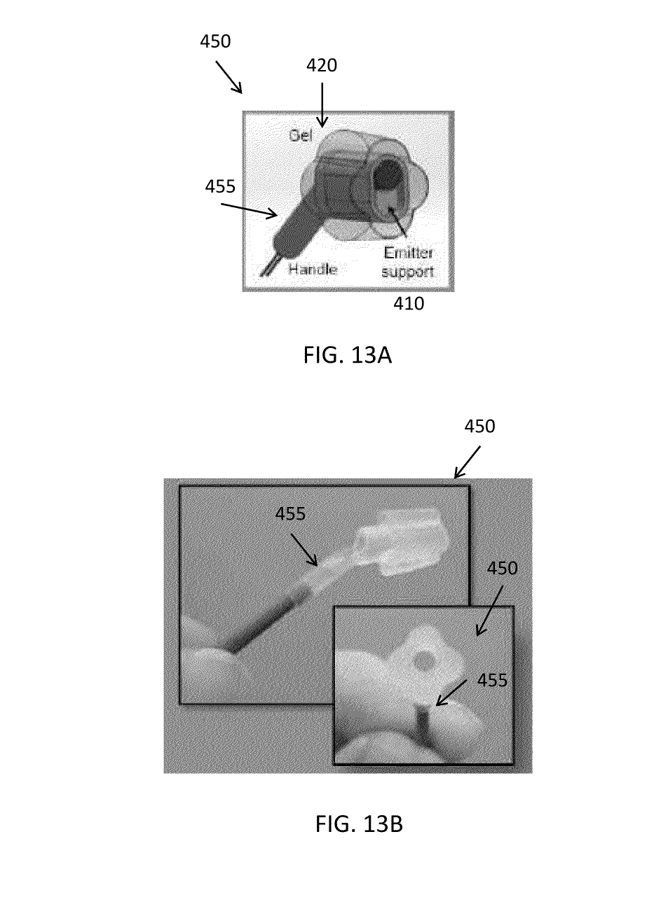

As shown in FIGS. 13A and 13B, the ear tip 450 may further comprise a handle 455 coupled to the proximal or lateral portion of the ear tip 450. The handle 455 may facilitate the insertion and placement of the ear tip 450.

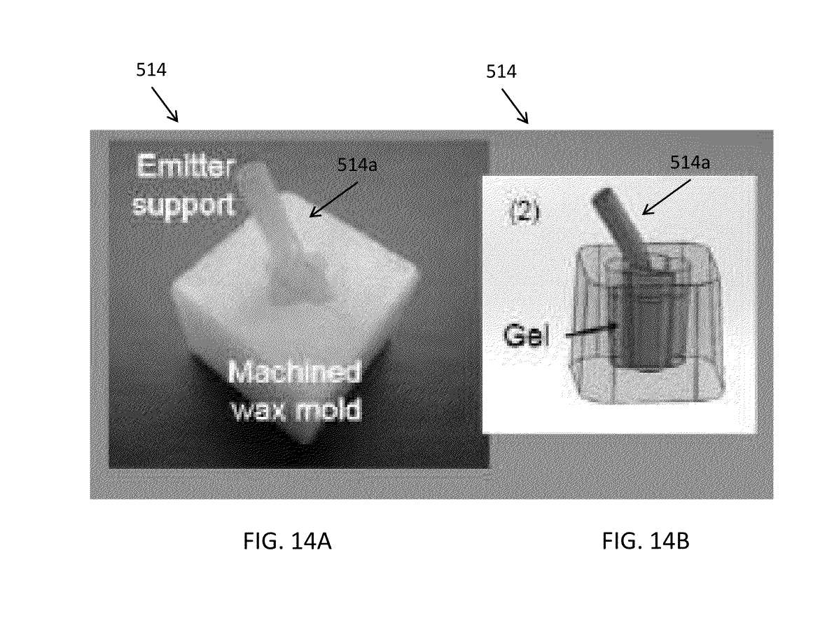

Aspects of the present disclosure further provide methods of manufacturing or fabricating the various improved ear tips described herein. The improved ear tips may be fabricated using, for example, a sacrificial mold process. The sacrificially mold made be made in different ways such as direct machining, direct 3D printing or by casting from a rubber master which may be made by 3D printing. An exemplary sacrificial wax mold 14 is shown in FIGS. 14A and 14B. An emitter support 514a may be placed into the wax mold 514, and gel material may be injected into the wax mold and cured around the emitter support. The wax is then removed. The wax may be water-soluble and removed by dissolving in water. The sacrificial material may be another type of wax or plastic that can be removed by solvents and/or by heating. The wax mold 514 may be used to form the malleable element 120 or the gel portion 420 of the ear tips 100, 400, or 450 described above. The malleable element 120 or the gel portion 420 may be formed over the other components of the ear tips 100, 400, or 450, such as the wires 160, the output transducer 180, or the hard shell or core 410.

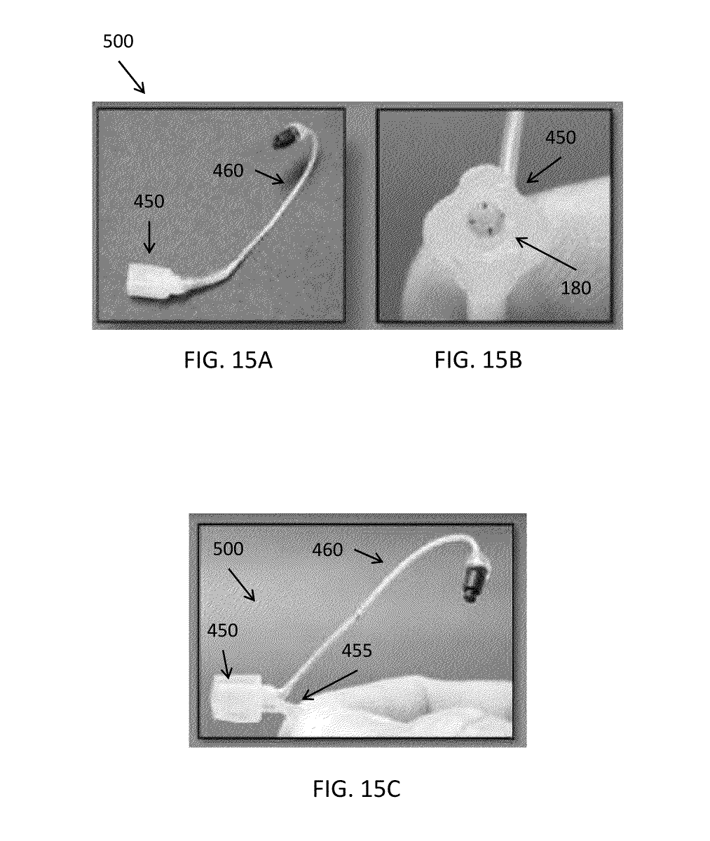

As shown in FIGS. 15A, 15B, and 15C, the ear tips, such as ear tip 450, may be provided as a component of a complete ear tip assembly 500. The inventor has fabricated and tested the complete ear tip assembly 500 shown in FIGS. 15A, 15B, and 15C. The ear tip assembly 500 may comprise the ear tip 450, the handle 455, and a cable section 460 extending proximally or laterally outward from the ear tip 450. When the ear tip 450 is placed in the ear canal, for instance, the cable section 460 may extend out of the ear canal to a “behind the ear” or BTE unit (not shown) that contains microphone, speaker, battery and electronic signal processing capability. The BTE unit may convert sound to a useful electrical signal that is delivered by cable section 460 to the output transducer 180 to generate an optical signal to a tympanic membrane receiver 350, for example.

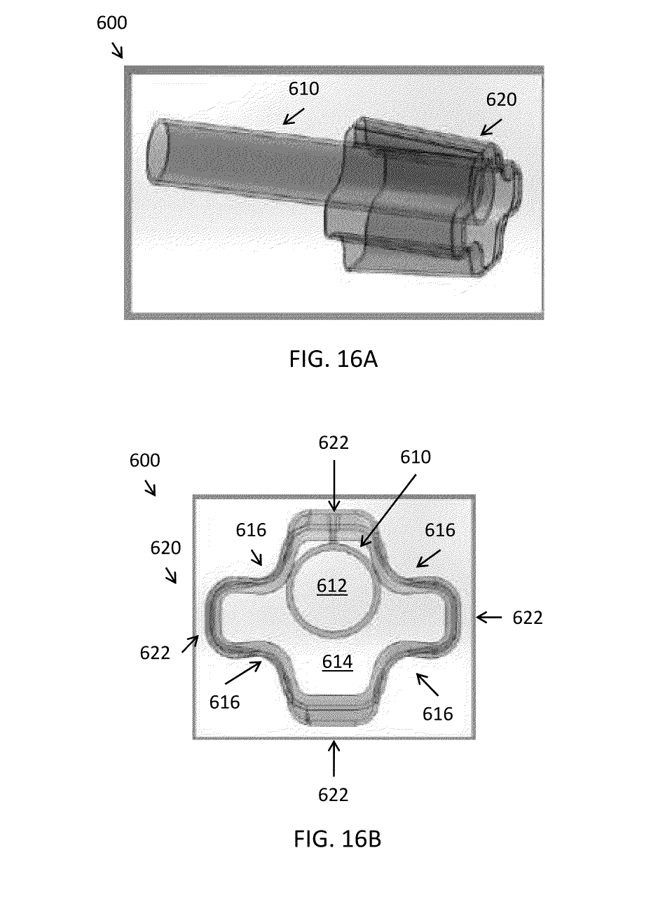

FIGS. 16A and 16B show another embodiment of the ear tips, for example, an ear tip 600 which comprises a thin shell or core. The thin shell may have a thickness of 50 to 500 μm and comprise silicone, for example. The ear tip 600 may comprise a shaft portion 610 and an ear canal contact portion 620. The thin shell may define several openings for venting the ear canal, a shaft opening 612 of the shaft portion 610, a central opening 614 defined between the shaft portion 610 and the ear canal contact portion 620, and a plurality of channels 616 to be defined between the outer surfaces of relief or cut-away portions of the ear canal contact portion 620 and the inner wall of the ear canal. The channels or folds 616 also serve to reduce radial pressure of the tip on the ear canal wall and to increase conformability of the ear tip to different ear-canal cross-section shapes. The folds 616 allow the structure to bend to reduce the radial pressure, circumventing potential generation of larger hoop stresses and pressure that could occur without folds. The ear canal contact portion 620 may be cross-shaped to be aligned with the major and minor axes of the ear canal through ear canal wall contacting extensions 622 which may define the aforementioned relief or cut-away portions disposed between adjacent extensions 622. The ear tip 600 may be fabricated by injecting material such as silicone or silicone rubber into a simple, 3-D printed mold.

Section 610 may be variable in cross section and may hold one or more wires that connect a BTE unit to a transducer. 610 may also be curved to follow the shape of the ear canal. A transducer may be located in the tip 612. The leading (medial) edge of the tip may be curved to help facilitate easy insertion in the ear canal.

One or more processors may be programmed to perform various steps and methods as described in reference to various embodiments and implementations of the present disclosure. Embodiments of the systems of the present application may be comprised of various modules, for example, as discussed below. Each of the modules can comprise various sub-routines, procedures and macros. Each of the modules may be separately compiled and linked into a single executable program.

It will be apparent that the number of steps that are utilized for such methods are not limited to those described above. Also, the methods do not require that all the described steps are present. Although the methodology described above as discrete steps, one or more steps may be added, combined or even deleted, without departing from the intended functionality of the embodiments. The steps can be performed in a different order, for example. It will also be apparent that the method described above may be performed in a partially or substantially automated fashion.

As will be appreciated by those skilled in the art, the methods of the present disclosure may be embodied, at least in part, in software and carried out in a computer system or other data processing system. Therefore, in some exemplary embodiments hardware may be used in combination with software instructions to implement the present disclosure. Any process descriptions, elements or blocks in the flow diagrams described herein and/or depicted in the attached figures should be understood as potentially representing modules, segments, or portions of code which include one or more executable instructions for implementing specific logical functions or elements in the process. Further, the functions described in one or more examples may be implemented in hardware, software, firmware, or any combination of the above. If implemented in software, the functions may be transmitted or stored on as one or more instructions or code on a computer-readable medium, these instructions may be executed by a hardware-based processing unit, such as one or more processors, including general purpose microprocessors, application specific integrated circuits, field programmable logic arrays, or other logic circuitry.

While preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed in practicing the invention. By way of non-limiting example, it will be appreciated by those skilled in the art that particular features or characteristics described in reference to one figure or embodiment may be combined as suitable with features or characteristics described in another figure or embodiment. It is intended that the following claims define the scope of the invention and that methods and structures within the scope of these claims and their equivalents be covered thereby.

What is claimed is:

1. An ear tip apparatus for use with a hearing device, the ear tip comprising:
a malleable structure sized and configured for placement in an ear canal of a user, the malleable structure having a cross-section shaped to define at least one channel between an inner wall of the ear canal and an outer surface of the malleable structure for venting of the ear canal,
wherein the malleable structure is deformable to adjust the cross-section thereof so as to vary a size of the at least one channel to adjust a degree of venting provided by the at least one channel.

2. The apparatus of claim 1, further comprising an actuator coupled to the malleable structure and operable to cause the malleable structure to deform.

3. The apparatus of claim 2, wherein the actuator comprises a slider configured for translation and/or rotation relative to the malleable structure.

4. The apparatus of claim 3, wherein the slider comprises one or more threads to facilitate rotation relative to the malleable structure.

5. The apparatus of claim 3, wherein translating the slider toward the malleable structure deforms the malleable structure to increase the size of the at least one channel to reduce the degree of venting provided by the at least one channel.

6. The apparatus of claim 3, wherein the actuator further comprises an elongate element coupled to the malleable structure and the slider, wherein the malleable structure is disposed over the elongate element and the slider is translatable over the elongate element.

7. The apparatus of claim 6, wherein the elongate element comprises one or more of a shaft, wire, or a post.

8. The apparatus of claim 2, wherein the actuator is configured to vary the degree of venting provided by the at least one channel in response to one or more of detected feedback or an environmental cue.

9. The apparatus of claim 8, wherein the actuator comprises one or more of a circuitry, a processor, or a mechanical element adapted to be responsive to one or more of the detected feedback or the environmental cue.

10. The apparatus of claim 8, wherein the detected feedback or the environmental cue is indicated from a sensor in communication with the actuator.

11. The apparatus of claim 10, wherein the sensor comprises one or more of a microphone, an accelerometer, a vibration sensor, an internal sensor of the ear tip apparatus, or a sensor of a control device external of the ear tip apparatus.

12. The apparatus of claim 10, wherein the communication is at least partially electronic or at least partially wireless.

13. The apparatus of claim 8, wherein the actuator is configured to vary the degree of venting provided by the at least one channel in response to one or more of a volume or a sound directionality of an ambient environment.

14. The apparatus of claim 13, wherein the actuator is configured to increase the degree of venting in a loud ambient environment, thereby allowing the user to hear more unprocessed sound, or to decrease the degree of venting in a loud ambient environment, thereby allowing the user to hear more processed sound.

15. The apparatus of claim 1, wherein the malleable structure is deformable between a low cross-sectional area configuration and a high cross-sectional area configuration, the at least one channel providing more venting when the malleable structure is in the low cross-sectional area configuration than when in the high cross-sectional area configuration.

16. The apparatus of claim 15, wherein the malleable structure is biased to assume the low cross-sectional area configuration.

17. The apparatus of claim 1, wherein the malleable structure has one or more of a Y-shaped, X-shaped, or cross-shaped cross-section.

18. The apparatus of claim 1, wherein the malleable structure comprises a gel.

19. The apparatus of claim 1, wherein the malleable structure comprises a fluid-filled bladder, the fluid-filled bladder comprising a bladder wall and a bladder fluid, and wherein the bladder wall comprising one or more of a stiff plastic or an elastomeric material.

20. The apparatus of claim 19, wherein the stiff plastic or elastomeric material comprises one or more of silicone, parylene, nylon, a PEBA material, Pebax, or polyurethane.

21. The apparatus of claim 19, wherein the bladder fluid comprises one or more of a gas, a liquid, or a gel.

22. The apparatus of claim 18, wherein the gel comprises one or more of a silicone gel, a viscous hydrophilic fluid, a viscous hydrophobic material, a thixotropic material, a viscoelastic material, a dilatant material, a rheopectic material, Nusil MED-6670, Nusil MED-6346, Nusil MED-6345, a polyurethane gel, a polyvinylpyrrolidone gel, a polyethylene glycol gel, glycerol, thickened glycerol, petroleum jelly, mineral oil, lanolin, silicone oil, or grease.

23. A method for reducing occlusion in a hearing device placed in an ear canal of a user, the method comprising:
deforming a malleable structure placed in the ear canal to vary a size of at least one channel to adjust a degree of venting provided by the at least one channel,
wherein the malleable structure is sized and configured for placement in the ear canal and has a cross-section shaped to define the at least one channel between the inner wall of the ear canal and an outer surface of the malleable structure.

24. The method of claim 23, wherein deforming the malleable structure comprises one or more of translating or rotating a slider relative to the malleable structure.

25. The method of claim 24, wherein the slider is translated or rotated over an element, wherein one or more of the slider or the malleable structure is disposed over the element.

26. The method of claim 25, wherein translating or rotating the slider relative to the malleable structure transitions the malleable structure from a low cross-sectional area configuration to a high cross-sectional area configuration.

27. The method of claim 23, wherein the malleable structure comprises a gel.

28. The method of claim 23, further comprising adjusting the degree of venting in response to one or more of detected feedback or an environmental cue.

29. The method of claim 28, wherein the detected feedback or the environmental cue is indicated from a sensor and wherein the sensor comprises one or more of a microphone, an accelerometer, a vibration sensor, an internal sensor of the hearing device, or a sensor of a control device external of the hearing device.

30. The method of claim 28, further comprising increasing the degree of venting in a loud ambient environment, thereby allowing the user to hear more unprocessed sound or decreasing the degree of venting in loud ambient environment, thereby allowing the user to hear more processed sound.

31. An ear tip apparatus comprising:
a hard core configured for placement in an ear canal, the hard core having a lateral portion and a medial portion; and
a gel portion disposed over at least the medial portion of the hard core, the gel portion being configured to deform and conform to the ear canal.

32. The ear tip apparatus of claim 31, wherein an exposed outer surface of the hard core has a length that does not extend past an isthmus of the ear canal when the ear tip apparatus is inserted in the ear canal.

33. The ear tip apparatus of claim 31, wherein an outer surface of the gel portion is shaped to define one or more channels for venting of the ear canal.

34. The ear tip apparatus of claim 31, further comprising one or more transducers for transmitting sound to the user, the one or more transducers being housed within the rigid shell.
